(19) United States
(12) Patent Application Publication
(10) Pub. No.: US 2013/0078422 A1
(43) Pub. Date: Mar. 28, 2013

(54) ACOUSTIC INSULATION WITH PERFORMANCE ENHANCING SUB-STRUCTURE

(71) Applicants: Brandon Dillan Tinianov, Santa Clara, CA (US); Kent Severin Whiting, Campbell, CA (US); Frank Warren Bishop, JR., Los Altos, CA (US)

(72) Inventors: Brandon Dillan Tinianov, Santa Clara, CA (US); Kent Severin Whiting, Campbell, CA (US); Frank Warren Bishop, JR., Los Altos, CA (US)

(73) Assignee: Frank Warren Bishop, JR., Los Altos, CA (US)

(21) Appl. No.: 13/608,952

(22) Filed: Sep. 10, 2012

Related U.S. Application Data
(60) Provisional application No. 61/538,744, filed on Sep. 23, 2011.

(51) Int. Cl. B32B 3/24; B32B 5/26; B32B 3/26; B32B 29/02; D03D 25/00; D04H 13/00

(52) U.S. Cl. 428/138; 442/181; 442/327; 428/311.71; 428/311.91; 442/246; 442/381

(57) ABSTRACT

An insulation batt for use in building structures is presented. The insulation batt includes an air flow resistive layer of material provided between portions of insulating material.

### CROSS-REFERENCE TO RELATED APPLICATION

This application claims the benefit of U.S. Provisional Patent Application No. 61/538,744 filed on Sep. 23, 2011, under 35 U.S.C. 119(e).

### BACKGROUND

1. Field of the Invention

Embodiments described in the present disclosure relate generally to the field of acoustic insulation for buildings and other architectural applications.

2. Description of Related Art

In the field of thermal and acoustic insulation for walls, ceilings, floors, and doors used in buildings and other architectural structures, insulation materials are often placed in the interior cavities of framed partitions. Example interior cavities include the volume between studs in a gypsum wallboard wall assembly or the interior cavity created by a multi-leaf door panel. These insulation materials are manufactured as a thick batt or blanket comprised of many layers of fine diameter fibers bonded into a three dimensional matrix with a binder or binding agent. The batt is generally homogeneous with regard to material, fiber orientation, and density, and acoustic material properties. In some cases the exterior surface or surfaces of the blanket or batt may be laminated with or clad by a covering layer on one or more exterior surfaces to facilitate handling, installation, or for water vapor management. Examples of such clad insulation products are “Kraft-Faced” and “ComfortTherm” fiberglass manufactured by Johns Manville of Denver Colo., and “CertoPro” and “Kraft Faced” fiberglass by CertainTeed Corporation of Valley Forge, Pa. While these materials and structures may provide an efficient thermal insulation, they typically lack the ability to enhance the acoustic attenuation at select frequencies due to a homogeneous design that provides a limited broadband sound attenuation. Even in cases where the insulating batt is clad with a covering layer on its outermost surfaces, sound attenuation performance is not improved. A covering layer in the outermost surface does not enhance the acoustic performance of the insulation in a system involving a partition with a cavity. In fact, current insulation manufacturers do not specify different levels of performance for their products according to their exterior covering or lack thereof.

Therefore, there is a need for enhanced acoustic and thermal insulation materials and methods to be used in architectural applications to enhance sound attenuation in the cavity of acoustically rated partitions used in buildings and other architectural applications.

### SUMMARY

An insulation batt for use in building structures according to embodiments disclosed herein may include a batt having an air flow resistive layer of material provided between portions of insulating material.

These and other embodiments are further described below with reference to the following figures.

### BRIEF DESCRIPTION OF THE DRAWINGS

FIG. 1 shows a cross sectional view of an insulation batt according to some embodiments.

FIG. 2A shows a cross sectional view of an insulation batt according to some embodiments.

FIG. 2B shows a cross sectional view of an insulation batt according to some embodiments.

FIG. 3 shows a perspective view of an insulation batt according to some embodiments.

FIG. 4 shows a cross sectional view of a wall structure according to some embodiments.

FIG. 5 shows a cross sectional view of a ceiling structure according to some embodiments.

FIG. 6 shows a chart including test results for sound insulation in wall structures according to some embodiments.

FIG. 7 shows a structure including an HVAC duct wrapped with an insulation batt according to some embodiments.

### DETAILED DESCRIPTION

Noise control is a rapidly growing economic and public policy concern for the construction industry. Areas with high acoustical isolation (commonly referred to as ‘soundproofed’) are desirable and required for a variety of purposes. Apartments, condominiums, hotels, schools and hospitals all require rooms with walls, ceilings and floors that reduce sound transmission thereby minimizing, or eliminating, the disturbance to people in adjacent rooms. Soundproofing is particularly important in buildings adjacent to public transportation, such as highways, airports and railroad lines. Additionally, facilities such as theaters, home theaters, music practice rooms, and recording studios require increased noise abatement. Likewise, hospitals and general healthcare facilities have begun to recognize acoustical comfort as an important part of a patient's recovery time. One result of the severity of multi-party residential and commercial noise control issues is the widespread emergence of model building codes and design guidelines that specify minimum Sound Transmission Class (STC) ratings for specific wall structures within a building. Another result is the broad emergence of litigation between homeowners and builders over the issue of unacceptable noise levels. In response, major builders have refused to build homes, condos and apartments in certain municipalities; and there is widespread cancellation of liability insurance for builders. The International Code Council has established that the minimum sound isolation between multiple tenant dwellings or between dwellings and corridors is a lab certified STC 50. Regional codes or builder specifications for these walls often require STC 60 or more. Such high performance levels are difficult to achieve and field tested designs often fail to perform to the required levels. The problem is compounded when a single wall or structure is value-engineered to minimize the material and labor involved during construction.

One common feature in building panels used in walls, ceilings, floors and other construction applications is a notable deterioration of the noise attenuation quality of the panel at low frequencies, particularly at or around 125 Hz. It would be highly desirable to have a building panel that is optimized in sound attenuation and vibration transmission properties such that vibration frequencies from about 50 to about 125 Hz (“problem frequencies”) are highly suppressed.

Various construction techniques and products have emerged to address the problem of noise control, but few are well suited to target these selected problem frequencies. Currently available choices include adding gypsum drywall layers, resilient channels and isolated drywall panels, and mass-loaded vinyl barriers with additional drywall panels; or cellulose-based sound board. All of these changes help reduce the noise transmission incrementally, but not to such an extent that identified problem frequencies would be considered fully mitigated (i.e. restoring privacy or comfort).

Embodiments disclosed herein are designed to be installed into building partitions with an open cavity, such as a stud framed wall or ceiling. According to some embodiments, an insulation batt or blanket may be sized to completely fill the cavity from stud to stud, the insulation batt including an intermediate airflow resistive layer generally parallel to the partition surfaces. The batt or blanket according to some embodiments may include a plurality of insulating portions made of fine diameter fibers. Fibrous materials used in some embodiments may include fiberglass, rock wool, mineral wool, polyester fibers, or denim/cotton fibers. According to some embodiments, one or more intermediate airflow resistive layers have a mass and an air flow resistance that are optimized to improve the transmission loss for specific frequencies in the noise spectrum.

Embodiments of insulation batts consistent with the present disclosure may be wrapped around structural elements of buildings to enhance sound and thermal isolation. For example, ducts used in heating, ventilation, and air conditioning (HVAC) systems may be wrapped or covered with insulation batts consistent with the present disclosure. In general, ducts carrying fluids (e.g. air or water) for different purposes in a building may be wrapped by insulation batts according to the present disclosure. Typically, ducts carrying fluids in buildings are a conduit of noise and undesirable vibrations, especially when the duct is fabricated with a hard material such as metal or vinyl. Thus, embodiments of the present disclosure may substantially eliminate the noise and vibration transmitted by these conduits, insulating the duct from other building elements.

The intermediate resistive layer separates the insulating matt or blanket into at least two portions parallel to the partition surfaces. In some embodiments, the two portions may have equal or nearly equal thickness. In some embodiments the portions of insulating material on either side of the resistive layer may have different thicknesses. Further according to some embodiments more than one intermediate resistive layer may be included in the insulating matt, resulting in three, four, or more layers of insulating material separated by a plurality of intermediate resistive layers.

In embodiments consistent with the present disclosure, the noise spectrum is a spectrum of sound frequencies that are desired to be attenuated. Typically, these frequencies are in the range from about 50-60 Hz to 1000 Hz. When installed into a wall assembly in exactly the same manner as traditional materials, insulation batts as disclosed herein may deliver approximately 3 dB of noise isolation improvement, between about 200 and 5,000 Hz.

Insulating materials used in some embodiments may include fiberglass mats, mineral wool or rock wool batts, cellulose insulation, or natural fiber batts using fibers made from denim or cotton. For example, some embodiments may use insulating materials from a denim fiber batt such as provided by Bonded Logic, Inc. of Chandler, Ariz. A denim fiber batt is formed from ground up denim jeans, bonded together with a PET (Poly-ethylene Terephthalate) binder to form a three-dimensional (3-D) batt.

Some figures of merit for this invention and for the components of the assembly are specific airflow resistance and airflow resistivity. Specific airflow resistance is the quotient of the air pressure difference across a material's area, divided by the volume velocity of airflow through the material specimen. This is equivalent to the air pressure difference across the specimen divided by the linear velocity of airflow measured outside the material when tested per ASTM test method C522. The units of specific air flow resistance are Pa.s/m, also known as ‘mks rayl.’ Airflow resistivity is the quotient of the specific airflow resistance of a homogeneous material divided by its thickness. Its units are Pa.s/m², termed mks rayl/m. The airflow resistance measurement method is defined by ASTM C522 “Standard Test Method for Airflow Resistance of Acoustical Materials.” This standard is available online at the ASTM web page, and is incorporated herein by reference in its entirety for all purposes. According to embodiments disclosed herein, a high value of specific airflow resistance is desirable in order to reduce sound transmission through pressure waves traveling in the air contained inside a partition cavity.

A figure of merit for the sound attenuating qualities of a sound rated partition is its Sound Transmission Class (STC). The STC number is a rating which is used in the architectural field to rate partitions, doors and windows for their effectiveness in reducing the transmission of sound. The rating assigned to a particular partition design is a result of acoustical testing and represents a best fit type of approach to a set of curves that define the sound transmission class. The STC measurement method is defined by ASTM E90 “Standard Test Method Laboratory Measurement of Airborne Sound Transmission Loss of Building Partitions and Elements,” and ASTM E413 “Classification for Sound Insulation,” used to calculate STC ratings from the sound transmission loss data for a given structure. These standards are available online at the ASTM web page, and are incorporated herein by reference in their entirety for all purposes.

Building partitions that may benefit in STC performance by using insulation blankets according to embodiments disclosed herein include many typical lightweight 25 gauge steel framed wall assemblies. For example, a single stud wall assembly with a single layer of type X gypsum wallboard on each side and a common homogeneous fiber insulation batt (fiberglass, mineral fiber, or cotton fiber) provides inadequate acoustical performance. Such a single stud wall has been laboratory tested to an STC 48, which is below building code requirements (STC 50, 60, or more). The rating of such walls is limited by poor transmission loss at 125, 160 and 2500 Hz. In many cases, sound absorption performance is about five to ten decibels lower than it is at other, nearby frequencies. For example, at 200 Hz, the wall performs about 6 decibels better (higher transmission loss) than it does at the adjacent measurement frequency, 160 Hz. The subject batt insulation with an air resistive substructure according to embodiments disclosed herein improves the STC of a sound rated partition at these target frequencies. In one embodiment, an insulation batt with a single air resistive layer having a mass of about 1 kg/m² and an airflow resistance of between 200 and 900 mks rayls can improve the transmission loss across a broad frequency range from about 200 Hz to about 5,000 Hz. The STC rating for a wall using this insulation embodiment improves by 3 points to an STC 51, which is building code compliant for a sound rated partition.

A figure of merit of a material used for thermal insulation in architectural applications is the R-value. The R-value is a reciprocal of the measure of a system or assembly's thermal transmission, or the rate of heat transfer through the system. Therefore, the higher the R-value the lower the amount of heat loss, and the product is a better insulator. The units of R-values may be given as hr·ft ²·° F. /Btu (inverse of a British thermal unit—Btu—per hour, per square feet, per degree Fahrenheit). Conversion to MKS units is through: 1 Btu/(hr·ft²·° F.)=5.666 W/(m² K) (Watts per meter squared, per degree Kelvin). R-values are defined according to the insulation resistance test set forth by the American Society for Testing and Materials in the Annual Book of ASTM, incorporated herein by reference in its entirety for all purposes.

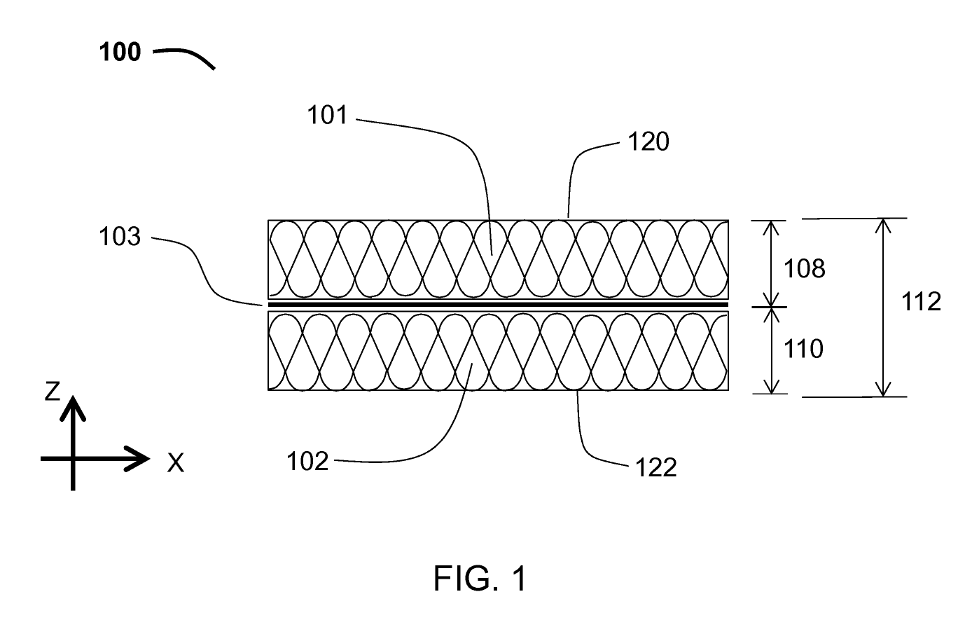

FIG. 1 shows a cross sectional view of an insulation batt 100 according to some embodiments. Insulation batt 100 is divided into portions 101 and 102 by airflow resistive layer 103. In some embodiments, the materials selected for portions 101 and 102 may be a fiberglass, mineral fiber, or natural fiber insulation batt. The density of the batt material can vary from less than about 8 Kilograms per cubic meter (0.5 pounds per cubic foot—pcf—) to more than about 48 Kilograms per cubic meter (about 3 pcf) depending on the density or acoustic requirements. In some embodiments, the materials selected for airflow resistive layer 103 may be woven cotton fabric, a woven synthetic fabric, a non-woven synthetic scrim, or a non-woven fiberglass scrim. Further according to some embodiments, portion 101 may include materials different from the materials included in portion 102.

The air flow resistance (expressed in mks rayls) of the interlayer material used in portion 103 (“air flow resistive layer”) is a parameter that may be used to optimize the noise attenuation properties of blanket 100, according to some embodiments. The interlayer material for airflow resistive layer 103 can be selected to enhance broadband or select frequency transmission loss.

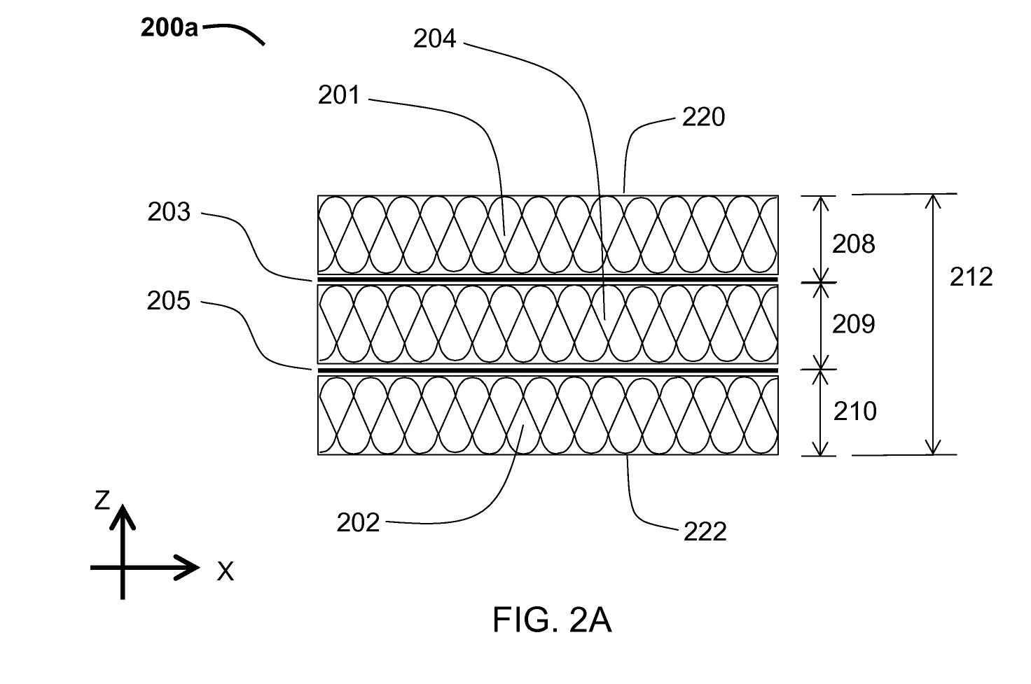

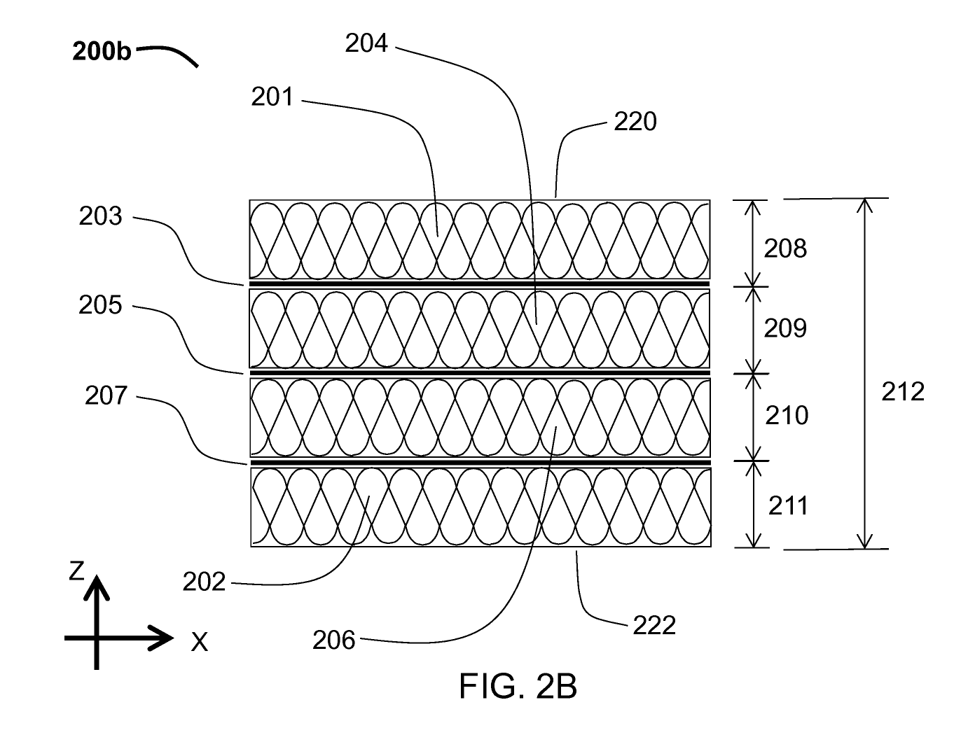

The mass of resistive layer 103 may influence a maximum noise attenuation frequency. For example, the higher the mass of airflow resistive layer 103 the lower the noise frequency experiencing maximum attenuation. The positioning of airflow resistive layer 103 may also be adjusted according to the desired noise attenuation. According to embodiments consistent with the present disclosure one or more airflow resistive layers 103 may be placed in various locations along the z-direction of the batt. This is described in detail below, in conjunction with FIGS. 2A and 2B. In some embodiments it is desirable to place airflow resistive layer 103 near the center of matt 100.

In some embodiments, insulation batt 100 includes an airflow resistive layer 103 having a mass of about 2 kg/m² and an airflow resistance of between 700 and 900 mks rayls. Such insulation batt improves the transmission loss performance across a target frequency range of 100 Hz to 250 Hz.

FIG. 1 shows an insulation batt 100 having a thickness 112 in the z direction. In embodiments consistent with the present disclosure thickness 112 may be between 20 and 500 mm. In some embodiments a thickness 112 between 90 and 150 mm is preferred. Suitable thicknesses 112 for batt 100 may vary depending on the particular application and thermal performance required of the insulation material. Insulation batts having a thickness of about one inch (about 25 mm) or more may be chosen for embodiments used to wrap around large HVAC ducts. According to embodiments disclosed herein, airflow resistive layer 103 is positioned at a distance 108 along the z-axis from upper surface 120 and at a distance 110 along the z-axis from lower surface 122. In one embodiment, distances 108 and 110 are equal. That is, embodiments of insulation batt 100 may have a single airflow resistive layer 103 at about the midpoint of batt thickness 112. In some embodiments, dimension 110 is up to three times greater than dimension 108.

The physical properties of airflow resistive layer 103 may vary depending on the material used in airflow resistive layer 103 and the specific application needs. According to embodiments consistent with the present disclosure, airflow resistive layer 103 may have an airflow resistance of about 200 to 900 MKS rayls. In some embodiments, airflow resistive layer 103 may have an airflow resistance of about 200 to 600 MKS rayls. Further according to some embodiments, airflow resistive layer 103 may have an airflow resistance of about 100 to 500 MKS rayls.

The materials used to make airflow resistive layer 103 may vary depending on the specific needs of a given application. Airflow resistive layer 103 may be formed of a woven fabric of selected airflow resistance. In some embodiments, airflow resistive layer 103 is formed from a nonwoven sheet of selected airflow resistance. Some embodiment consistent with the present disclosure may provide airflow resistive layer 103 formed of a semi-porous paper of selected airflow resistance. Further according to some embodiments, airflow resistive layer 103 may be formed of a perforated film of selected airflow resistance.

FIG. 2A shows a cross sectional view of an insulation batt 200a according to some embodiments. Insulation batt 200a is divided into portions 201, 202 and 204 by airflow resistive layers 203 and 205. Insulation blanket 200a has a thickness 212 in the z direction. In some embodiments, dimension 212 is between 20 and 500 mm. In some embodiments a thickness 212 between 90 and 150 mm may be preferred. In some embodiments airflow resistive layers 203 and 205 are positioned at intermediate distances between the upper and lower surfaces 220 and 222 of insulation batt 200a. In one embodiment thicknesses 208, 209 and 210 are equal. Thus, airflow resistive layers 203 and 205 may be positioned at about the first third and the second third of batt thickness 212. In some embodiments, dimension 209 is up to three times greater than dimension 208 and 210.

FIG. 2B shows a cross sectional view of an insulation batt 200b according to some additional embodiments. Insulation batt 200b is divided into portions 201, 202, 204 and 206 by three airflow resistive layers 203, 205 and 207. Insulation blanket 200b has a thickness 212 along the z direction. In some embodiments, thickness 212 is between 20 and 500 mm. In some embodiments thickness 212 is between 90 and 150 mm. In some embodiments of insulation batt 200b the three airflow resistive layers 203, 205, and 207 may be positioned at intermediate distances between upper and lower surfaces 220 and 222, respectively. In some embodiments thicknesses 208, 209, 210 and 211 are equal. Thus, airflow resistive layers 203, 205, and 207 may be placed at about the first quarter, the midpoint, and the third quarter of batt thickness 212, respectively. In some embodiments, dimensions 209 and 210 are up to three times greater than dimensions 208 and 211.

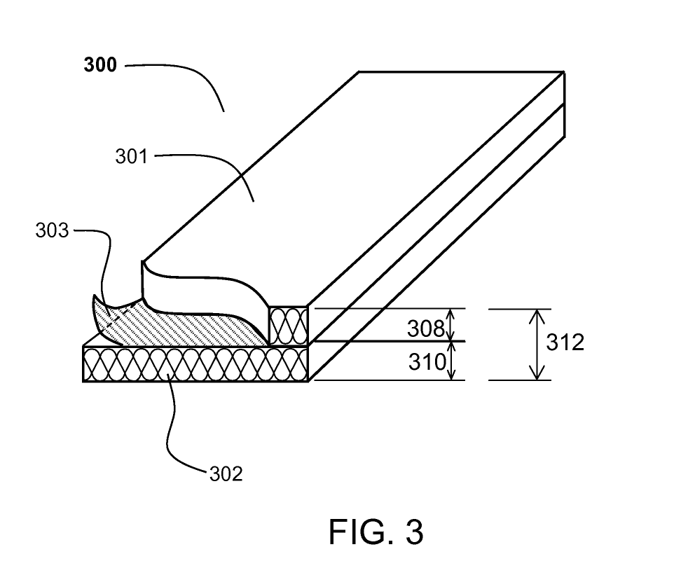

FIG. 3 shows a cross sectional view of an insulation batt 300 according to some embodiments. Insulation batt 300 includes portions 301 and 302, separated by airflow resistive layer 303. In some embodiments, portions 301 and 302 in blanket 300 may include the same material. For example, portions 301 and 302 may be formed from a denim fiber batt as described above.

In some embodiments, insulation batts consistent with the present disclosure are formed of nonwoven fibers on either side of an intermediate air flow resistive layer (see FIGS. 1-3). The material forming insulating portions 101, 102, 201, 202, 204, 206, 301, and 302 (cf. FIGS. 1-3) may be lofted to a specific density to achieve the acoustic resistivity and thermal R-value required for a given application. A particular example of materials used for portions 101, 102, 201, 202, 204, 206, 301, and 302 is a nonwoven lofted denim insulation batt or blanket produced from shredded denim, commonly known as “shoddy.” One such material, produced by Bonded Logic of Prescott, Ariz. is a blend of about 90% recycled denim fibers that contains about 10% of low melt polyester fibers that serve as a bonding agent within the fibrous matrix. The airflow resistance of a 3.5 inch thick insulation portion such as 101, 102, 201, 202, 204, 206, 301 and 302 is about 350 mks rayls or has an equivalent airflow resistivity of about 2500 mks rayls/m, according to some embodiments.

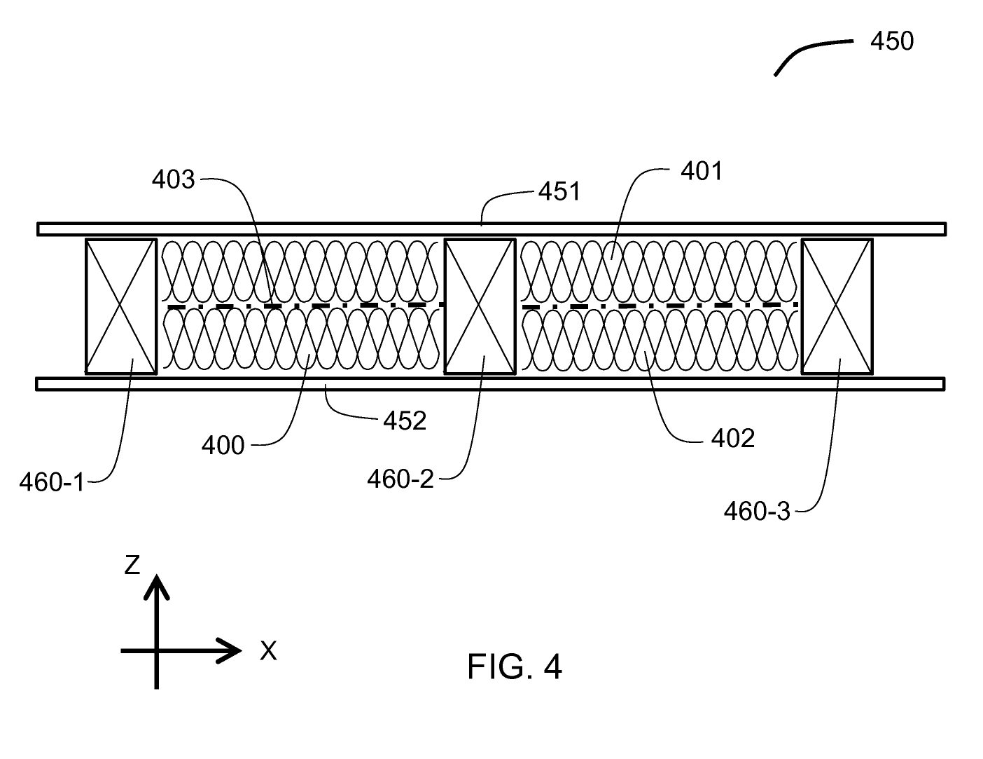

FIG. 4. Shows a cross-sectional view of a wall structure 450 according to some embodiments. In embodiments consistent with the present disclosure wall structure 450 includes wallboard panels 451 and 452 separated by studs 460-1 through 460-3. Studs 460-1 through 460-3 and panels 451 and 452 form an interior cavity where insulation batt 400 is placed, according to some embodiments. Insulation batt 400 includes portions 401 and 402 separated by airflow resistive layer 403.

In some embodiments, insulation batt 400 is designed in such a way that a distance exists between resistive layer 403 and either of wallboard panels 451 and 452. It is desirable to have a portion of fibrous matt (such as 401 or 402) be provided a minimum thickness to separate airflow resistive layer 403 from panels 451 and 452. Such a separation prevents acoustic coupling between panels 451 and 452, and airflow resistive layer 403.

According to embodiments consistent with the present disclosure, studs 460-1 through 460-3 may be formed of wood. In some embodiments, studs 460-1 through 460-3 are made of metal such as a steel sheet formed into a hollow shape (see FIG. 4). Further according to some embodiments, insulation batt 400 may reach inside the hollow cavity of studs 460-1 through 460-3. Such an embodiment may provide further noise attenuation for sound transmitted through studs 460-1 through 460-3. Studs 460-1 through 460-3 may have an aperture on one side facing the interior cavity formed between the studs and panels 451 and 452, allowing a portion of insulation batt 400 to reach inside the hollow cavity of the stud.

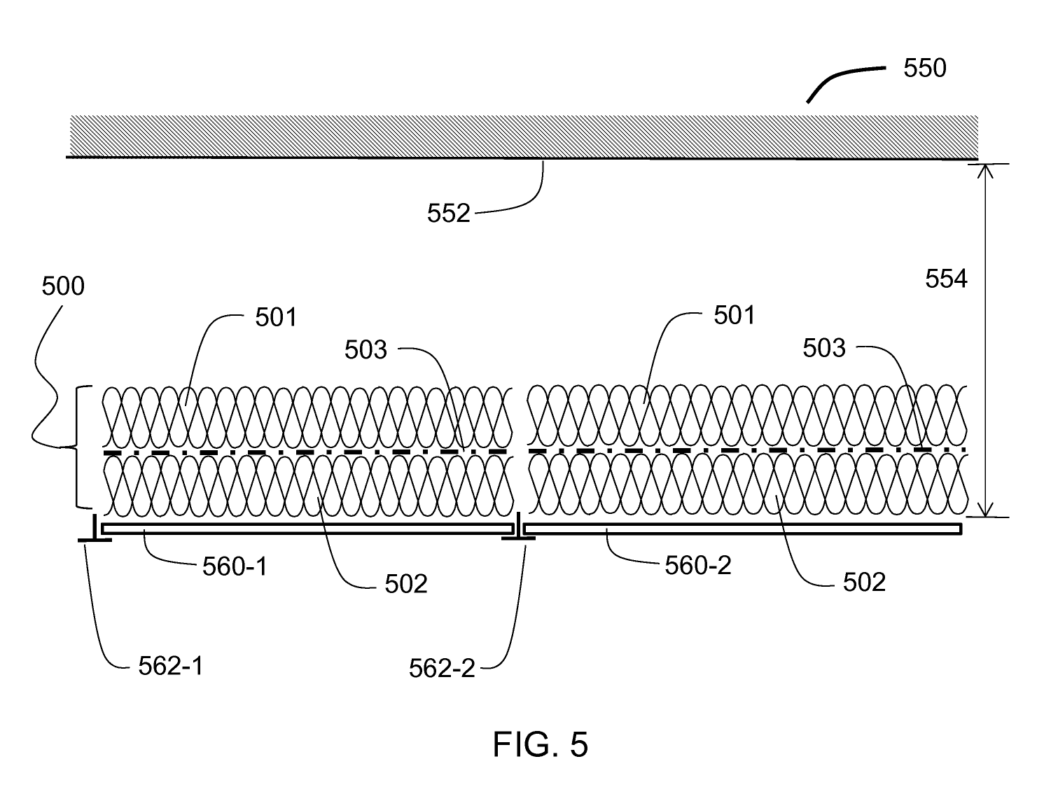

FIG. 5 shows a cross-sectional view of a ceiling structure 550 according to some embodiments. In embodiments consistent with the present disclosure, ceiling structure 550 includes ceiling slab or deck 552 separated from the ceiling plane by an airspace 554 with a span of about 6 inches to about 36 inches. The ceiling plane consists of multiple individual tiles 560-1 and 560-2 supported by supporting grid elements 562-1 and 562-2 commonly termed t-bars. Ceiling tile 560-1 and 560-2 may consist of mineral wool, fiberglass, or gypsum panels. The ceiling slab 552 and tiles 560-1 and 560-2 form an interior cavity where insulation batt 500 is placed, according to some embodiments. Insulation batt 500 includes portions 501 and 502 separated by airflow resistive layer 503.

According to embodiments consistent with the present disclosure, the ceiling plane 560-1 and 560-2 may also be formed of a continuous sheet consisting of gypsum drywall or wood.

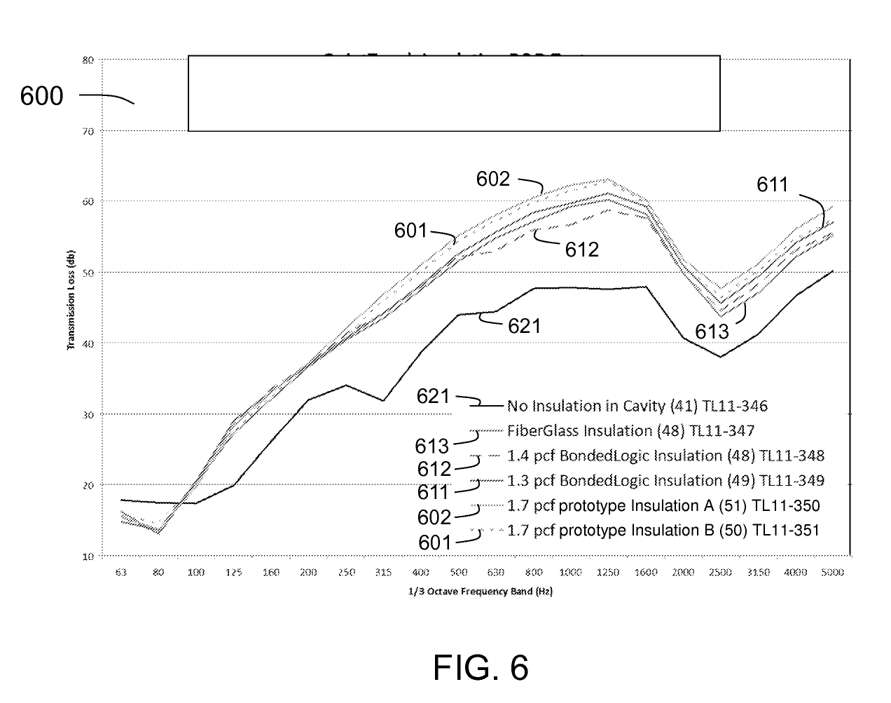

FIG. 6 shows a chart 600 including test results for sound insulation in wall structures according to some embodiments. Chart 600 has an ordinate (Y-axis) showing the transmission loss (in decibels—dB—) of a building partition. The abscissa (X-axis) in Chart 600 shows the sound frequency for which the transmission loss is measured. According to embodiments consistent with the present disclosure, the values of sound frequency used to create Chart 600 may correspond to ⅓ octave frequency bands as specified in ASTM E413 standards. Structures having results as depicted in FIG. 6 may include a cavity formed by two wallboard elements supported by studs, such as wall structure 450 (see FIG. 4). In some embodiments consistent with the present disclosure, studs 460-1 through 460-3 may be steel studs made from a 25 gauge steel sheet folded into a square cross section. The square cross-section may have a length of 3⅝ inches and a 24 inch outer contour (OC) or perimeter. Also, embodiments resulting in Chart 600 may use a single Type X Gypsum layer having a ⅝″ thickness for wallboards 451 and 452. Chart 600 includes curves 601, 602, 611, 612, 613 and 621, each curve being associated with a specific STC value as described above.

Curve 601 corresponds to embodiments consistent with wallboard 450 having insulation batt 400 as in a prototype Insulation A, test sample no. TL11-350, resulting in an STC value of 51. The average density of the insulation batt used in the embodiment corresponding to curve 601 is 1.7 pcf. Curve 602 corresponds to embodiments consistent with wallboard 450 having insulation batt 400 as in prototype Insulation B, test sample no. TL11-351, resulting in an STC value of 50. The average density of the insulation batt used in the embodiment corresponding to curve 602 is 1.7 pcf. The insulation batt used in curves 601 and 602 employs embodiments of the acoustic enhancing substructure as shown in the present disclosure.

For prototype Insulation A, a resistive layer such as airflow resistive layer 103 (see FIG. 1) is a woven cotton fabric bonded via spray adhesive to the denim batts. The airflow resistance of an insulating batt such as used to obtain curve 601 is approximately 300 mks rayls. The airflow resistance of an insulating batt such as used to obtain curve 602 is approximately 500 mks rayls. For prototype Insulation B, airflow resistive layer 103 is a non-woven fiberglass paper or scrim, bonded via spray adhesive to the denim batts.

Curves 611, 612, and 613 correspond to a wall structure with 25 gauge steel studs 460 and a single Type X gypsum board in each of wallboards 451 and 452, such as described above in relation to curves 601 and 602. However, curves 611, 612, and 613 make use of an insulation batt in the cavity formed between studs 460-1 through 460-3 and wallboards 451 and 452 as in the prior art. Thus, insulation batts as used to obtain curves 611, 612, and 613 each have a single piece of insulation material, without an airflow resistive interlayer. For example, a single piece of insulation batts used to obtain curves 611, 612, and 613 may be as either one of portions 101 and 102 (see FIG. 1). Curve 611 corresponds to a wall structure 450 having an insulation batt as provided by Bonded Logic Inc.'s Insulation, test sample no. TL11-349, resulting in an STC value of 49. The average density of the insulation batt used in the embodiment corresponding to curve 611 is 1.3 pounds per cubic foot (pcf). Curve 612 corresponds to embodiments consistent with wall structure 450 having an insulation batt as in Bonded Logic Inc.'s UltraTouch Insulation, test sample no. TL11-348, resulting in an STC value of 48. The average density of the insulation batt used in the embodiment corresponding to curve 611 is 1.4 pcf. Note the increased average density of the insulation batt consistent with curve 611, to the insulation batt consistent with curve 612; and a reduction of the STC value of the wall assemblies between the two insulation batts. This indicates that in the prior art the mass of the insulation batt has a limited effect, if any, improving the sound insulation property of the resulting building partition. Sound transmission through an intermediate cavity (cf. FIG. 4) is primarily carried out through pressure waves traveling via the air or insulation filling the cavity. Curve 613 corresponds to wallboard 450 having insulation batt consisting of a fiberglass batt approximately 3.5 inches thick and a thermal performance value of R-13. The wall sample with fiberglass insulation cavity fill was test number TL11-347, and resulted in an STC value of 48.

Curve 621 corresponds to a wall structure with 25 gauge steel studs 460 and a single, Type X gypsum board as wallboards 451 and 452, such as described above in relation to curves 501 and 502. However, structures resulting in curve 621 have no insulation batt in the cavity formed between studs 460-1 through 460-3 and wallboards 451 and 452. The test number for curve 621 is TL11-346, and the resulting STC value is 41.

FIG. 6 shows that embodiments consistent with the present disclosure such as those resulting in curves 601 and 602 provide superior sound transmission loss compared to the prior art. In general, the sound transmission loss is equal to or better than the prior art in the frequency range from at least 63 Hz to at least 5000 Hz. In particular, in the range from about 200 Hz to about 5000 Hz the sound transmission loss improvement is about 3 dB or higher for insulation batt embodiments such as disclosed herein. Likewise, the STC value increases by 3 points.

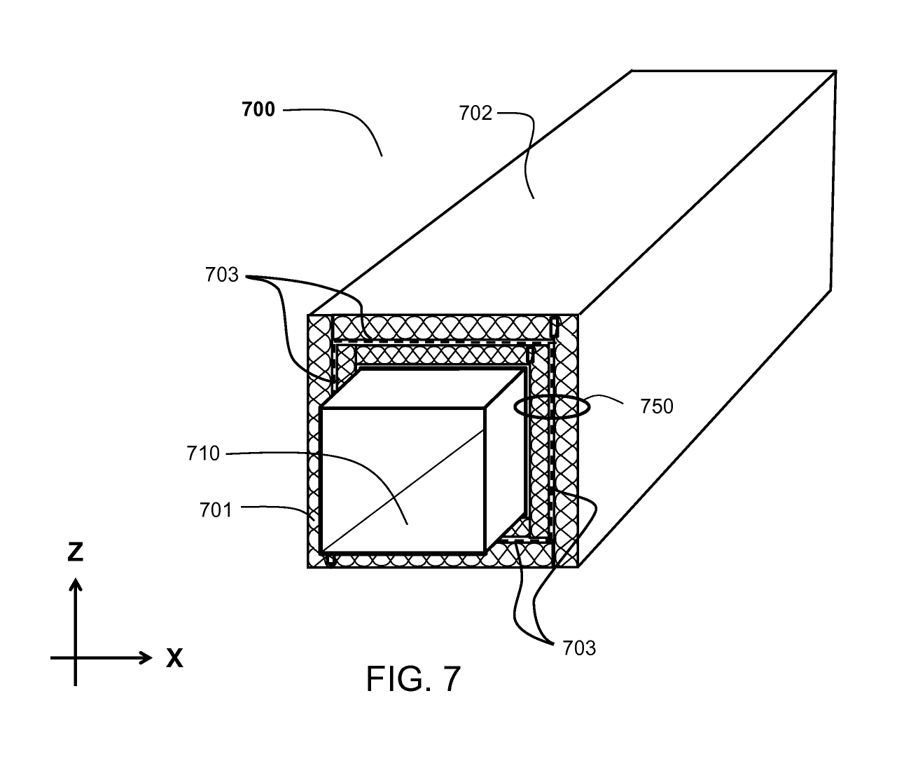

FIG. 7 shows a structure 700 including an HVAC duct 710 wrapped with an insulation batt 750, according to some embodiments. HVAC duct 710 may have a square cross-section, as shown in FIG. 7. In some embodiments, HVAC duct 710 may have a circular cross-section, or any other shape. Further, in some embodiments consistent with the present disclosure element 710 may be a structural element in a building, such as a stud, or any other element providing structural support to the building, or providing functionality such as water drainage. HVAC duct 710 may be formed of aluminum, steel, galvanized steel or any other metal or metal alloy according to some embodiments. Furthermore, HVAC duct 710 may be formed of vinyl or a hardened plastic material, or a fiberglass duct board, according to some embodiments.

Insulation batt 750 may include portions 701 and 702 formed from an insulating material and separated by airflow resistive layer 703, as shown in FIG. 7. According to embodiments consistent with the present disclosure, portions 701 and 702 may be as portions 101 and 102 above (see FIG. 1). Further according to some embodiments, airflow resistive layer 703 may be as airflow resistive layer 103 above (see FIG. 1). In some embodiments such as depicted in FIG. 7, portions 701 and 702 have a substantially equal thickness. Further according to some embodiments, insulation batt 750 may include a plurality of airflow resistive layers 703, separated by a plurality of portions of insulating material such as portions 701 and 702. In embodiments consistent with the present disclosure, airflow resistive layer 703 may form a continuous layer around HVAC duct 701.

Embodiments disclosed herein are illustrative only and not limiting. One of regular skill in the art will recognize that other embodiments consistent with the present disclosure may be possible. The present disclosure is limited only by the following claims.

What is claimed is:

1. An insulation batt for use in building structures, the batt comprising an air flow resistive layer of material provided between portions of insulating material.

2. The insulation batt of claim 1 wherein the insulating material is selected from the group consisting of fiberglass, mineral fibers, natural fibers, rock wool, mineral wool, polyester fibers, denim fibers, and cotton fibers.

3. The insulation batt of claim 1 wherein the portions of insulating material have equal thickness.

4. The insulation batt of claim 1, wherein the air flow resistive layer of material is a first air flow resistive layer of material and the portions of insulating material are first portion and second portion of insulating material, further comprising a second airflow resistive layer of material provided between the second portion of insulating material and a third portion of insulating material.

5. The insulation batt of claim 1 wherein the airflow resistive layer of materials is formed from a material selected from the group consisting of a woven fabric, a nonwoven sheet, a semi-porous paper, and a perforated film.

6. The insulation batt of claim 1, wherein the air flow resistive layer of material is a first air flow resistive layer of material, further comprising a second and a third airflow resistive layers of material.

7. The insulation batt of claim 6 wherein each of the three airflow resistive layers of materials is formed from a material selected from the group consisting of a woven fabric, a nonwoven sheet, a semi-porous paper, and a perforated film.

8. The insulation batt of claim 1 including an airflow resistive layer of material having an airflow resistance of about 200 to 900 MKS rayls.

9. The insulation batt of claim 1 including an airflow resistive layer of material having an airflow resistance of about 200 to 600 MKS rayls.

10. The insulation batt of claim 1 including an airflow resistive layer of material having an airflow resistance of about 100 to 500 MKS rayls.

11. The insulation batt of claim 1 including an airflow resistive layer of material formed from a woven fabric of selected airflow resistance.

12. The insulation batt of claim 1 including an airflow resistive layer of material formed from a nonwoven sheet of selected airflow resistance.

13. The insulation batt of claim 1 including an airflow resistive layer of material formed from a semi-porous paper of selected airflow resistance.

14. The insulation batt of claim 1 including an airflow resistive layer of material formed from a perforated film of selected airflow resistance.

15. The insulation batt of claim 1 configured to be wrapped around a duct in a building structure, the duct carrying a fluid used for heating or ventilation.

16. A structure for construction including an insulation batt coupled to a wall or ceiling panel, wherein the insulation batt comprises an air flow resistive layer of material provided between portions of insulating material.
